(19) United States
(12) Patent Application Publication
(10) Pub. No.: US 2024/0223362 A1
(43) Pub. Date: Jul. 4, 2024

(54) SYSTEM AND METHOD FOR DISTRIBUTION OF ENCRYPTED TRAFFIC IN A MULTIPLE INDEPENDENT LEVEL SECURITY ENVIRONMENT

(71) Applicant: Pesa Corporation, Markham (CA)

(72) Inventors: Scott A. BARELLA, Centennial, CO (US); James MURPHY,, Ft. Collins, CO (US)

(21) Appl. No.: 17/757,298

(22) PCT Filed: May 10, 2022
(86) PCT No.: PCT/IB2022/054345

§ 371 Date: Jun. 13, 2022

Related U.S. Application Data
(60) Provisional application No. 63/188,565, filed on May 14, 2021.

(51) Int. Cl. H04L 9/08

(52) U.S. Cl. CPC H04L 9/088

(57) ABSTRACT

What is disclosed is: A system for delivering real-time media traffic, comprising: A secure matrix communicatively coupled to a first bidirectional node, a second bidirectional node, and a control plane, wherein the first bidirectional node is communicatively coupled to a source. The first bidirectional node and the source have a first security level. The second bidirectional node is communicatively coupled to one or more destinations, and the second bidirectional node and the one or more destinations have a second security level. The first bidirectional node transmits a first encrypted real-time traffic to the secure matrix based on a first real-time media traffic received from the source. The control plane, using flow-based programming, configures the secure matrix to direct the first encrypted real-time traffic to the second bidirectional node, wherein the directing is based on the first security level, the second security level, and a security policy.

### FIELD OF THE INVENTION

The present disclosure relates to the distribution, delivery and routing of encrypted real-time media traffic.

### BRIEF SUMMARY

A system for delivering real-time media traffic, comprising: a secure matrix communicatively coupled to a first set of bidirectional nodes, a second set of bidirectional nodes, and a control plane, wherein the first set of bidirectional nodes comprises a first bidirectional node communicatively coupled to a source, the first bidirectional node and the source having a first security level, the second set of bidirectional nodes comprises a second bidirectional node communicatively coupled to one or more destinations, the second bidirectional node and the one or more destinations having a second security level, the real-time traffic comprises a first real-time media traffic received by the first bidirectional node from the source, the first bidirectional node transmits a first encrypted real-time traffic to the secure matrix, further wherein the first encrypted real-time media traffic is based on the received first real-time media traffic, and the control plane, using flow-based programming, configures the secure matrix to direct the first encrypted real-time traffic to the second bidirectional node, further wherein the directing is based on the first security level, the second security level, and a security policy, the second bidirectional node transmits a first decrypted real-time media traffic to the one or more destinations, and the first decrypted real-time media traffic is based on the first encrypted real-time media traffic.

A method for delivery of real-time media traffic, comprising: receiving, at a first bidirectional node, a first real-time media traffic from a source, the first bidirectional node and the first source having a first security level; transmitting, from the first bidirectional node, a first encrypted real-time traffic based on the received first real-time media traffic; and configuring, using flow-based programming, a secure matrix to direct the first encrypted real-time traffic to a second bidirectional node, wherein the second bidirectional node and one or more destinations have a second security level, and the directing is based on the first security level, the second security level and a security policy.

A method for delivery of real-time media traffic, comprising: providing a secure matrix coupled to a first and a second set of bidirectional nodes, the first set of bidirectional nodes comprising a first bidirectional node, the first bidirectional node coupled to a first source via a connection, the first bidirectional node receiving a first real-time media traffic from the first source and transmitting a first encrypted real-time traffic to the secure matrix, the first encrypted real-time traffic based on the received first real-time media traffic, and the first bidirectional node and the first source having a first security level; and providing a control plane coupled to the secure matrix, wherein the control plane configures, using flow-based programming, the secure matrix to direct the first encrypted real-time traffic to the second set of bidirectional nodes, further wherein the second set of bidirectional nodes comprises a second bidirectional node, the second bidirectional node is coupled to the one or more destinations, the second bidirectional node and the one or more destinations having a second security level, and the first encrypted real-time traffic is directed to the second bidirectional node based on the first security level, the second security level and a security policy.

A system for delivering real-time media traffic, comprising: a secure matrix communicatively coupled to a first bidirectional node, a second bidirectional node, and a control plane, wherein the first bidirectional node is communicatively coupled to a source, the first bidirectional node and the source having a first security level, the second bidirectional node is communicatively coupled to one or more destinations, the second bidirectional node and the one or more destinations have a second security level, the first bidirectional node transmits a first encrypted real-time traffic to the secure matrix based on a first real-time media traffic received from the source, and the control plane, using flow-based programming, configures the secure matrix to direct the first encrypted real-time traffic to the second bidirectional node, further wherein the directing is based on the first security level, the second security level, and a security policy.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1A shows an example embodiment of a system for secure delivery of encrypted real-time media traffic.

FIG. 1B shows detailed embodiments of one of the first set of bidirectional nodes and one of the second set of bidirectional nodes.

FIG. 2A shows a detailed embodiment of a forward section of one of the first set of bidirectional nodes.

FIG. 2B shows a detailed embodiment of a reverse section of one of the first set of bidirectional nodes.

FIG. 2C shows a flowchart of operation of the forward section of one of the first set of bidirectional nodes.

FIG. 3 shows an example embodiment of a secure matrix.

FIG. 4A shows a detailed embodiment of a forward section of one of the second set of bidirectional nodes.

FIG. 4B shows a detailed embodiment of a reverse section of one of the second set of bidirectional nodes.

FIG. 4C shows a flowchart of operation of the forward section of one of the second set of bidirectional nodes.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Many audio, video and USB distribution systems concern the distribution of signals such as uncompressed and unmodulated High Definition Multimedia Interface (HDMI), DisplayPort (DP) or Serial Digital Interface (SDI) video. Securing the transport of these signals poses challenges as most of these signals are used as real-time signals such as audio, video and Universal Serial Bus (USB) by consumers and professionals worldwide.

In environments which employ Multiple Independent Levels of Security (MILS), there is a need to ensure that users are able to access data for which they have the requisite security clearance. For example, in some embodiments the data is classified as, that is, assigned a security level which is either Unclassified, Classified, Secret or Top Secret. Then, in the context where certain environments have stated policies regarding these levels, Unclassified data is considered less sensitive than Classified data and so on until Top Secret, which is reserved for the most sensitive data. Users are assigned clearances or security levels based on these levels as well.

In some embodiments, data which is classified as Top Secret should only be viewed by users with a Top Secret security level. Data which is classified as Secret can be viewed by users with either Secret or Top Secret security level. A user with a Secret security level can view data or information with Secret, Classified or Unclassified security level. This is referred to as a multi-domain policy. In yet other embodiments, there are limits as to how far down a user with a security level can view data. In other embodiments, users can only view data which matches their classifications, that is, an exclusive policy. In yet other embodiments, a cross domain policy applies to selected portions of data, while an exclusive policy applies to the remaining portions of data. Decisions are made as part of a policy configuration.

Prior art systems for video in MILS environments have been demonstrated. For example, United States Patent Application Publication 2010/0031342 to Vogsland, filed on Apr. 11, 2008 and published on Feb. 4, 2010 describes a system which directs video to users based on their respective security clearances. However, the system described in United States Patent Application Publication 2010/0031342 is designed for rendered video and not real-time video. It is therefore not suitable to address challenges specific to real-time video.

Additionally, scalability and reliability are issues. container-based solutions such as Docker-based solutions have been proposed to improve scalability and reliability. An example of the use of container-based solutions for real-time media, in particular, video is in US Patent Application Publication 2020/0236406 to Bastian et al, filed Feb. 13, 2020 and published on Jul. 23, 2020. However, the system described in US Patent Application Publication 2020/0236406 is designed for sports broadcasting, where data, audio and video are unencrypted. It is therefore not suitable to address challenges specific to delivery of real-time encrypted media such as video in a MILS environment. Specifically, there is a need to create a MILS object that can be assigned in a way to create proper transport to various MILS levels independent of base encryption in these environments. As explained previously, a policy may state that a user may only be able to receive real-time encrypted media at a security level which is lower or the same as the security level assigned to the user. The system in US Patent Application Publication 2020/0236406 does not address these requirements and challenges.

A system and method for secure delivery of encrypted real-time media traffic in a MILS environment using a secure matrix, such as an Ethernet switch fabric, which overcomes the problems of prior art systems is discussed below. The system discussed below provides the advantages of improved stability and reliability. By using container-based solutions, the system below enjoys more scalability and reliability compared to the prior art systems.

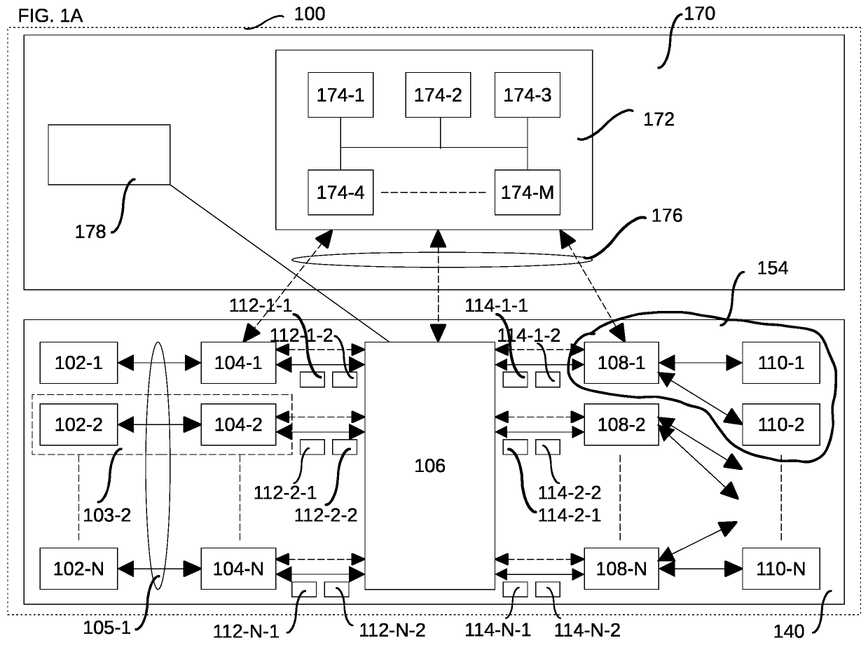

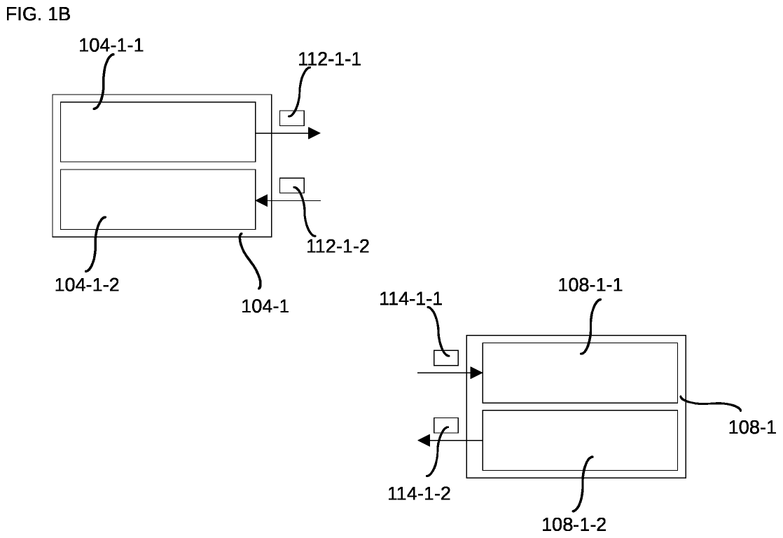

FIG. 1A shows an example embodiment of system 100 for secure delivery of encrypted real-time media traffic. In some embodiments, system 100 is divided into a data plane 140 and a control plane 170. Data plane 140 comprises sources 102-1 to 102-N which are coupled to a first set of bidirectional nodes 104-1 to 104-N over one or more connections 105-1. Connections 105-1 utilize one or more communicative technologies known to those of skill in the art, and will not be detailed further here. Sources 102-1 to 102-N generate corresponding input real-time media traffic which is then transmitted to the coupled bidirectional nodes 104-1 to 104-N. Due to the bidirectional nature of the system, sources 102-1 to 102-N also receive real-time traffic from destination nodes 110-1 to 110-N. Examples of sources 102-1 to 102-N are personal computers (PCs), thin/zero client devices, audio/video receivers and other devices.

In some embodiments, at least one of the bidirectional nodes 104-1 to 104-N are integrated with at least one of sources 102-1 to 102-N to form at least one integrated node. An example is an integrated camera node. For example, source node 102-2 is a camera, and is integrated with bidirectional node 104-2 to form integrated camera node 103-2. Another example is an integrated audio node, where the source/destination node is an audio source and is integrated with a corresponding bidirectional node to form an integrated audio node.

In some embodiments, at least one of 102-1 to 102-N is a USB source or destination, and it is connected to a corresponding at least one of bidirectional nodes 104-1 to 104-N, whereby the at least one of bidirectional nodes 104-1 to 104-N is a USB-only node. The USB-only nodes can provide USB 3.0/3.1 and lower USB 2.0 capabilities. Examples of USB devices are token readers, USB Common Access Card (CAC) readers, microphones, or other devices that produce traffic from a USB native port. A USB only node accepts USB traffic as an input, and outputs unicast traffic that is encrypted. This process will be described further below.

The nodes in the first set of bidirectional nodes 104-1 to 104-N transmit encrypted real-time media traffic 112-1-1 to 112-N-1 to the nodes in the second set of bidirectional nodes 108-1 to 108-N in accordance with the security level of the nodes in the first set, the nodes in the second set, and the security policy, as will be explained below. The nodes in the first set of bidirectional nodes receive encrypted real-time media traffic 112-1-2 to 112-N-2 from the nodes in the second set of bidirectional nodes 108-1 to 108-N in accordance with the security level of the nodes in the first set, the nodes in the second set, and the security policy, as will also be explained below.

In some embodiments, the bidirectional nodes 104-1 to 104-N have two sections corresponding to the direction of traffic. FIG. 1B shows an example embodiment where bidirectional node 104-1 has two sections 104-1-1 and 104-1-2 corresponding to the direction of the traffic. Section 104-1-1 transmits traffic 112-1-1, and section 104-1-2 receives traffic 112-1-2.

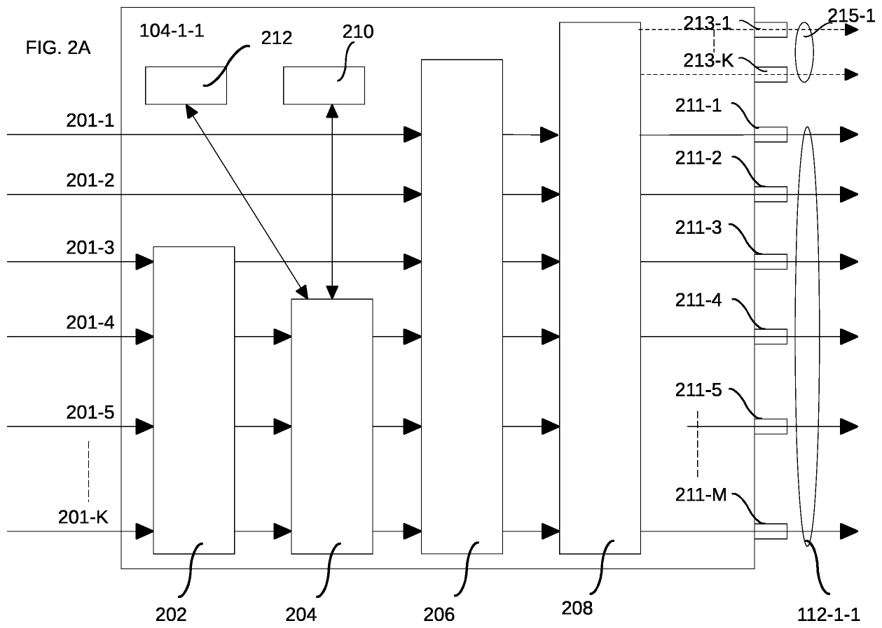

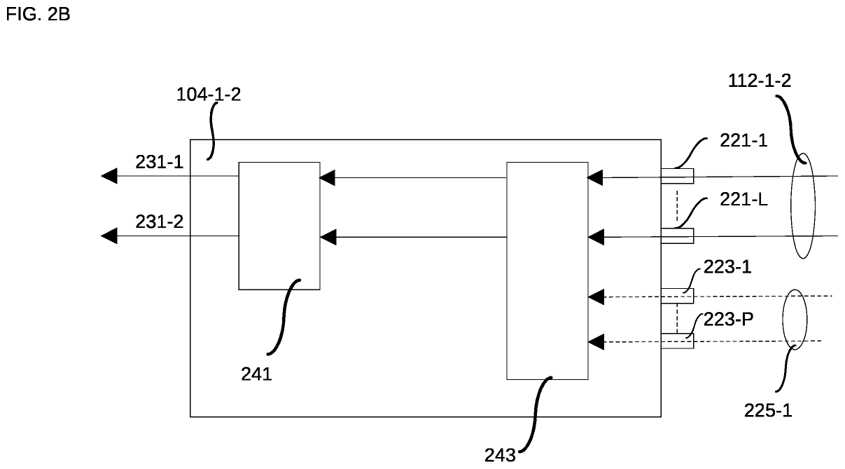

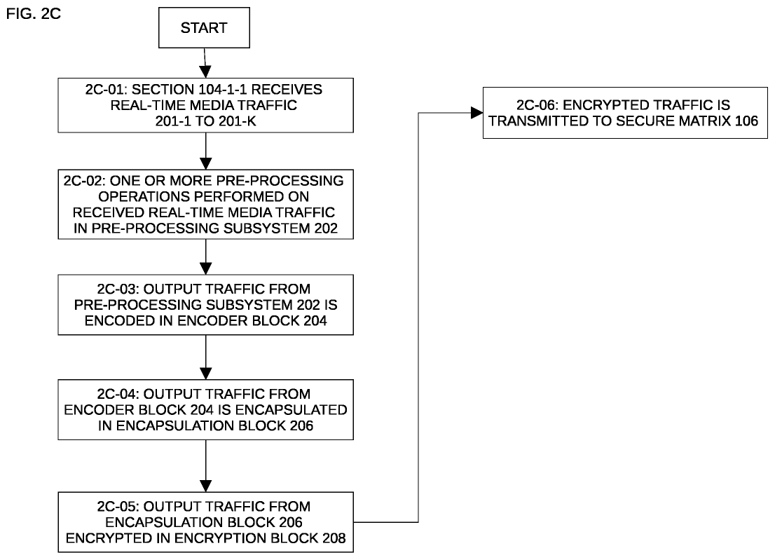

FIG. 2A shows a detailed embodiment of section 104-1-1 of bidirectional node 104-1. The operation of section 104-1-1 is shown with reference to FIGS. 2A and 2C. In step 2C-01, section 104-1-1 receives one or more types of real-time media traffic 201-1 to 201-K from source 102-1, for example. The one or more types of traffic 201-1 to 201-K are, for example, USB traffic, video traffic such as HDMI traffic and audio traffic. In some embodiments, the video traffic is uncompressed. In some embodiments, the audio traffic is uncompressed.

In some embodiments, in step 2C-02, one or more pre-processing operations are performed on the received one or more types of traffic 201-1 to 201-K. In some embodiments, these pre-processing operations are performed in pre-processing subsystem 202.

In some embodiments, the one or more pre-processing operations comprise splitting received traffic into independent flows. For example, when the type of traffic is HDMI or HDMI 2.0 A/V or HDMI 1.4 or HDMI 2.0 or DisplayPort 1.2 or DisplayPort 1.4 or USB-C or THUNDERBOLT™ and others the audio and video signals are split into two independent flows; one for audio and the other for video. In this manner users can choose to independently switch the audio without affecting video or in the case of a USB flow, being able to switch the USB for mouse and keyboard independently of the audio and video. As will be seen later, it also allows for users to combine video and audio at destinations.

In some embodiments, the one or more pre-processing operations comprises pre-scaling of video traffic received from the coupled source to enable viewing of multiple videos within a single monitor. For example, there may be a need to display four (4) different videos in a single monitor. For example, with reference to FIG. 2A, in some embodiments, traffic type 201-5 is video traffic. Then, in some of these embodiments the received video is pre-scaled into a plurality of versions, for example:
a first version comprising a full 3840×2160 progressive scan scale for fine viewing video details;
a second version with a slightly lower resolution such as a 1920×1080 progressive scan version; and
a third and fourth version which may have even lower resolutions, for example a 480×360 progressive version.
   These versions will be utilized later for viewing of multiple videos within a single monitor. In some embodiments, the pre-scaling is sufficient to enable the viewing of up to twelve (12) videos within a single monitor at a destination.

In step 2C-03, some of the pre-processed traffic output from pre-processing block 202 is encoded in encoder block 204. In some of the embodiments, the encoding comprises compression of some of the received real-time media signals. In some embodiments, the pre-processed traffic is converted to packets having a maximum transmission unit size of 1,350 bytes. In some embodiments, an encoder-decoder or “codec” is selected based on latency and compression ratio. It is known to those of skill in the art that in video codecs there is a tradeoff between latency and compression. In some embodiments, a mezzanine codec such as JPEG-2000 is used. Mezzanine codecs achieve extremely low latency at the cost of smaller compression ratios, thereby leading to larger payloads. In some embodiments, these mezzanine codecs are wavelet or Discrete Cosine Transform (DCT) based codecs. In other embodiments, motion-based codecs are used. These result in higher compression ratios, thereby leading to smaller payloads. However, motion-based codecs generally result in higher latencies. Typically, motion-based codecs are chosen when there is limited bandwidth on congested networks, while mezzanine codecs are chosen when latency is more likely to be a concern.

In some embodiments, step 2C-03 comprises transcoding. In some embodiments, a transcoder node such as node 210 is coupled to encoder 204 to provide transcoding functionalities. For example, a flow that requires transport over a secured Wide Area Network (WAN) where bandwidths are restricted requires a higher compression ratio. In this example, traffic which has been encoded by a mezzanine codec into a mezzanine format, is received by the transcoder node 210, decoded and then re-encoded using a motion-based codec into a motion-based format so as to improve bandwidth utilization. In some embodiments, the transcoder node 210 takes in traffic which has been encoded into a motion-based codec and converted to mezzanine format. This is useful in cases where latency is a more pressing requirement.

In some embodiments, step 2C-03 comprises recording video for playback. In some embodiments, recorder subsystem 212 records MILS authorized video and audio traffic, encrypts this traffic, and stores it securely using one or more file formats on a storage. In some embodiments, the storage is internal to recorder subsystem 212. In some embodiments, the storage is external to recorder subsystem 212. The storage is implemented using, for example, encrypted network attached storage (NAS) or other appropriate storage platforms. In yet other embodiments, audio is stored in accordance with the connected flows. In some embodiments, the files are stored in accordance with the MILS authorization. In some embodiments, the recorder subsystem 212 performs a playback function that plays encrypted files for review based on MILS level. In some embodiments, the size of the storage used is based on a duration requirement for stored video and the resolution of the video to be recorded. For example, the size of the storage set aside to store 30 minutes of video, is smaller than that of a storage set aside for 30 hours of video.

The transcoder node 210 and recorder subsystem 212 can be implemented in a variety of ways. In some embodiments, transcoder node 210 and recorder subsystem 212 are implemented in the same unit. In other embodiments, they are implemented in separate units. In some embodiments, recorder subsystem 212 is external to node 104-1. In some embodiments, recorder subsystem 212 is implemented using one or more servers. In some embodiments, recorder subsystem 212 is implemented using one or more of containers 174-1 to 174-M in container-based subsystem 172 in control plane 170. In yet other embodiments, recorder subsystem 212 is implemented using a cloud-based implementation.

In step 2C-04, the real-time media traffic is then encapsulated in encapsulation block 206. In some embodiments, encapsulation comprises adding an address to the packets. Based on whether the traffic is multicast or unicast, different addressing schemes are used. In some embodiments, multicast addressing is used for a video or audio flow to enable the video or audio flow to be connected to multiple destinations. In some embodiments, the video and USB traffic are unicast flows, which are only connected to a single destination. Then, in the case of unicast traffic, Internet Protocol (IP) source port addresses are used.

In some embodiments, the multicast traffic needs to traverse cloud environments, virtual private network (VPN) tunnels or WAN. Sending multicast traffic to cloud environments, VPN tunnels or WANs requires that the multicast traffic be translated to unicast traffic, and the multicast IP addresses are translated using Network Address Translation (NAT) to enable unicast transmission. In some of these embodiments, when the multicast traffic which has been previously converted to the unicast traffic departs either the cloud environment, VPN tunnel or WAN, then this unicast traffic is converted back to multicast traffic.

In step 2C-05, the traffic from encapsulation block 206 is encrypted in encryption block 208 to produce encrypted real-time media traffic 112-1-1. In some embodiments, a sufficiently strong scheme is used for encryption. Examples of such encryption schemes include but are not limited to those which meet governmental or military standards such as the United States (US) Federal Information Processing Standard Publication (FIPS) 140-2, FIPS 140-3, Advanced Encryption System (AES) 256, or any similar standard worldwide. In some embodiments, encryption block 206 is certified in accordance with a cryptographic validation program such as the Cryptographic Module Validation Program (CMVP).

The bidirectional nodes 104-1 to 104-N are coupled to a secure matrix 106 such as, for example, an Ethernet secure matrix or secure IP matrix 106. In some embodiments, the coupling is achieved using one or more Ethernet switches. The secure matrix 106 is also communicatively coupled to bidirectional nodes 108-1 to 108-N. In some embodiments, this is achieved using transmission media such as copper-based or optical-fiber-based media and appropriate communication technologies known to those of skill in the art. The secure matrix 106 plays the role of directing the encrypted real-time media traffic 112-1-1 to 112-N-1 output from the bidirectional nodes 104-1 to 104-N to the required destinations via the bidirectional nodes 108-1 to 108-N. The secure matrix 106 also plays the role of directing traffic 112-1-2 to 112-N-2 to bidirectional nodes 104-1 to 104-N.

With reference to bidirectional node 104-1, in step 2C-06, the traffic is encrypted. Then, encrypted real-time media traffic 112-1-1 is transmitted from section 104-1-1 via one or more data interfaces 211-1 to 211-M to secure matrix 106. The one or more data interfaces 211-1 to 211-M are coupled to secure matrix 106 via appropriate transmission media. In some embodiments, the one or more data interfaces 211-1 to 211-M are small form-factor pluggable (SFP) or small form-factor pluggable plus (SFP+) interfaces. In other embodiments, the one or more data interfaces 211-1 to 211-M are Registered Jack 45 (RJ45+) interfaces. In some embodiments, the transmission media is based on optical fiber. In other embodiments, the transmission media is copper based.

One of skill in the art would appreciate that variations to the above are possible. In some embodiments, no pre-processing or encoding operations are performed. For example, with reference to FIG. 2A, no pre-processing operations are performed on received types of traffic 201-1 and 201-2. This corresponds to the case where, for example, traffic 201-1 and 201-2 are USB traffic. Then, with reference to the flow shown in FIG. 2C, this traffic does not undergo steps 2C-02 and 2C-03.

In yet other embodiments, some of the traffic output from pre-processing subsystem 202 is sent directly to encapsulation block 206. For example, traffic 201-3 in FIG. 2A is output directly to encapsulation block 206 from pre-processing subsystem 202. Then, with reference to the flow shown in FIG. 2C, this traffic does not undergo step 2C-03.

In other embodiments, as shown in FIG. 2A, the bidirectional nodes 104-1 to 104-N comprise one or more control interfaces 213-1 to 213-K to transmit encrypted control traffic 215-1 to container-based subsystem 172, which will be explained in more detail below. The one or more control interfaces 213-1 to 213-K are coupled to secure matrix 106 via one or more transmission media. In some embodiments, the transmission media is copper-based. In other embodiments, the transmission media is optical-fiber-based. In some embodiments, the transmission media is a mix of copper-based and optical-fiber-based media. The secure matrix 106 is coupled to container-based subsystem 172 via one or more control connections 176.

As explained above, and with reference to FIG. 1B, bidirectional node 104-1 comprises a section 104-1-2 for receiving traffic 112-1-2. Section 104-1-2 is communicatively coupled to secure matrix 106 using transmission media as described above, and communication technologies known to those of skill in the art. FIG. 2B shows an embodiment of section 104-1-2. In section 104-1-2, encrypted real-time media traffic such as traffic 112-1-2 is received at ports 221-1 to 221-L from secure matrix 106. It is firstly decrypted at decryption block 243, then transmitted to block 241 for further post-processing before transmission to source 102-1 via ports 231-1 and 231-2. Section 104-1-2 plays the role of receiving encrypted control traffic such as control traffic 225-1 via, for example, ports 223-1 to 223-P from container-based subsystem 172, as explained above.

While the first set of nodes has been shown as having 2 sections corresponding to each direction of traffic, one of skill in the art would know that there are other ways of implementing bidirectional nodes. For example, in some embodiments, ports 211-1 to 211-M and 213-1 to 213-K of bidirectional node 104-1 in FIG. 2A comprise transceivers which transmit and receive data and control traffic from the secure matrix 106, thereby obviating the need for ports 221-1 to 221-L and 223-1 to 223-P. In some of these embodiments, encapsulation block 204 and encryption block 208 also incorporate the functionalities of decryption block 243 and decapsulation block 241.

As shown in FIG. 1A, the secure matrix 106 is communicatively coupled to a second set of bidirectional nodes 108-1 to 108-N. This communicative coupling is achieved using, transmission media such as copper- or optical-fiber-based transmission media or mixed copper-optical fiber as explained above; and communication technologies known to those of skill in the art. Then, the second set of bidirectional nodes 108-1 to 108-N receives encrypted real-time media traffic 114-1-1 to 114-N-1 from the first set of bidirectional nodes 104-1 to 104-N via the secure matrix 106, in accordance with the security level associated with the nodes in the first set of bidirectional nodes, the security level associated with the node in the second set of bidirectional nodes and the security policy, as will be explained below.

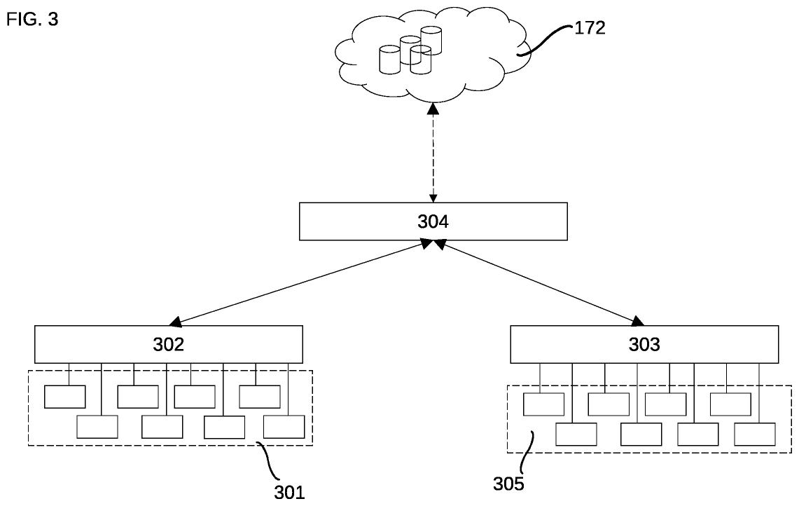

FIG. 3 shows an example embodiment of the secure matrix 106. In some embodiments, the secure matrix is based on a leaf and spine architecture. The operation of a leaf and spine switch architecture is well known to those of skill in the art and will not be discussed further here. As one of skill in the art would also know, the secure matrix can be based on other architectures which are suitable for this purpose, for example, leaf-to-leaf architectures.

An example embodiment is shown in FIG. 3, whereby leaf switches 302 and 303 are coupled to spine switch 304. Leaf switch 302 is coupled to endpoints 301, while leaf switch 303 is coupled to endpoints 305. Endpoints 301 and 305 are, for example nodes from first set of bidirectional nodes 104-1 to 104-N and second set of bidirectional nodes 108-1 to 108-N. Due to the bidirectional nature of the system, it is possible that routes could begin at endpoints 301 and end at endpoints 305, and vice versa.

To maintain correct functioning of the secure matrix 106, it is necessary to monitor all flows and connections, as well as ensure that traffic levels at each of the uplink and downlink ports in the switches are not exceeded and are balanced across the uplink and downlink ports of the switches. In some embodiments, a Software Defined Networking (SDN) container in container-based subsystem 172 performs these scheduling and routing functions and also ensures Quality of Service (QOS). In some embodiments, secure matrix 106 uses a non-blocking network architecture to ensure that audio and video flows are not interrupted. In some embodiments, the SDN container maintains encrypted FIPS communications with every node connected to the network. The SDN container uses this to become aware of unauthorized connections, and is able to notify security officers of potential security threats. The SDN container will be further explained below.

In some embodiments, the scheduling and routing functions comprise “joining”, where sending and receiving endpoints are joined to each other, so that the receiving endpoints can receive multicast flows using Internet Group Management Protocol (IGMP). In some embodiments, joining comprises a receiving endpoint sending a layer 2 call to, for example, one or more of switches 302, 303 or 304. This may pose a security risk, as an unauthorized receiving endpoint could make a layer 2 call to a switch to receive a multicast flow. In some embodiments, some receiving endpoints are authorized using an Access Control List (ACL), such that only those receiving endpoints on the ACL can make the layer 2 call to the one or more switches.

As will be explained below, the container-based subsystem 172 in control plane 170 is responsible for configuring and controlling the secure matrix and directing the encrypted real-time media traffic between the endpoints. In some embodiments, the container-based subsystem 172 configures the secure matrix 106 using flow-based programming (FBP). Many current processor architectures tend to be multiple-core-based. FBP is ideally suited to take advantage of multiple-core architectures by providing asynchronous processing without locks. A FBP node is quiescent until a message is enqueued onto its input queue. This means that an FBP node only uses the CPU or GPU when required. Beyond that, given the distributed independent nature of FBP, moving a node from one process to another only entails placing a Transmission Control Protocol (TCP) forwarder node between processes or machines. This then provides for scaling well beyond a single machine in the need arises. These features of FBP match well with the needs for modern distributed threaded systems. For example, functions related to the control and configuration of the secure matrix 106, such as scheduling and routing the real-time traffic, are implemented by container-based subsystem 172 in a multi-threaded manner using techniques based on flow-based programming. In some embodiments, secure matrix 106 utilizes a break-before-make scheme so as not to momentarily double the bandwidth as a make-before-break scheme would. In some embodiments, a Kubernetes-based environment is used, and pods are used as containers. In further embodiments, the pods are used to implement security.

Similarly, the second set of bidirectional nodes 108-1 to 108-N transmits encrypted real-time media traffic 114-1-2 to 114-N-2 to the first set of bidirectional nodes 104-1 to 104-N via the secure matrix 106 in accordance with the security levels and security policy as explained above.

In some embodiments the bidirectional nodes in the second set comprises two sections. As shown in FIG. 1B, the bidirectional node 108-1 comprises two sections, wherein each section corresponds to the direction of traffic. For example, section 108-1-1 of FIG. 1B is for receiving traffic 114-1-1 from the secure matrix 106, whereas section 108-1-2 of FIG. 1B is for transmitting traffic 114-1-2 to the secure matrix 106.

The second set of bidirectional nodes 108-1 to 108-N are communicatively coupled to destinations 110-1 to 110-N via transmission media such as copper-based or optical-fiber-based media or mixed media as described above, and using appropriate communicative technologies known to those of skill in the art. One or more destinations can be coupled to an associated bidirectional node. For example destinations 110-1 and 110-2 are coupled to bidirectional node 108-1. Then, the bidirectional node 108-1 decrypts, decodes and transmits the real-time signals to the coupled associated destination nodes 110-1 and 110-2 for display, aural or USB use. In some embodiments, the combination of a bidirectional node and destinations it is coupled to is referred to as a “seat”. For example, as shown in FIG. 1A, seat 154 comprises the combination of bidirectional node 108-1 and coupled destinations 110-1 and 110-2.

In some embodiments, the destinations comprise one or more peripheral devices. The one or more peripheral devices comprise, for example,
hearing apparatus for audio;
viewing display apparatus such as monitors for video viewing; and
USB extension devices such as keyboard, mouse, CAC reader, token or public key infrastructure (PKI) reader, USB microphone or other suitable USB device.

Then real-time traffic received from the bidirectional node is supplied to the coupled one or more peripheral devices.

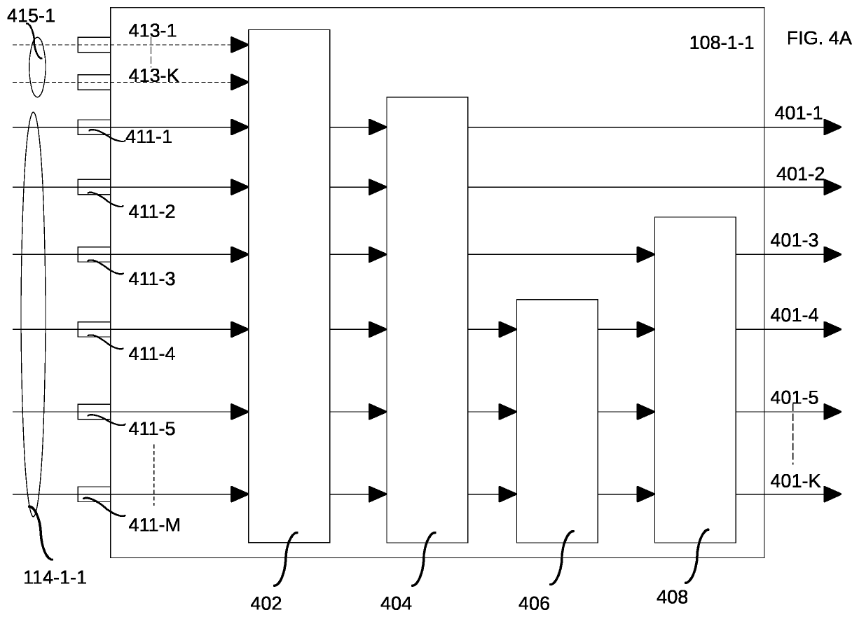

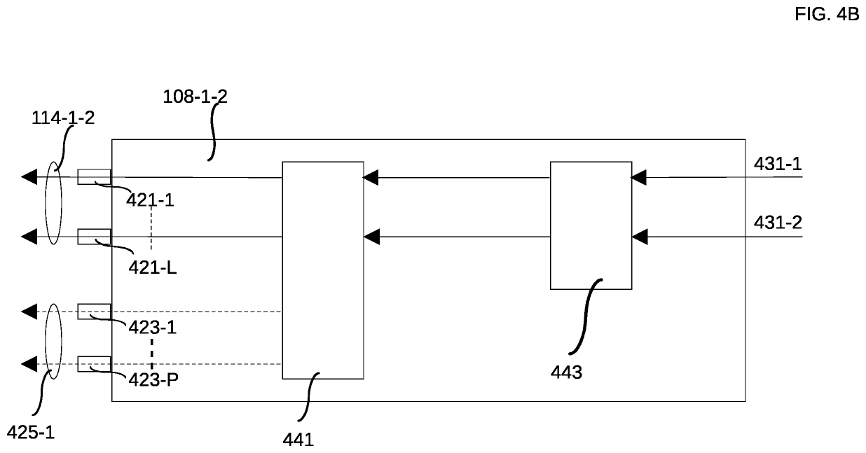

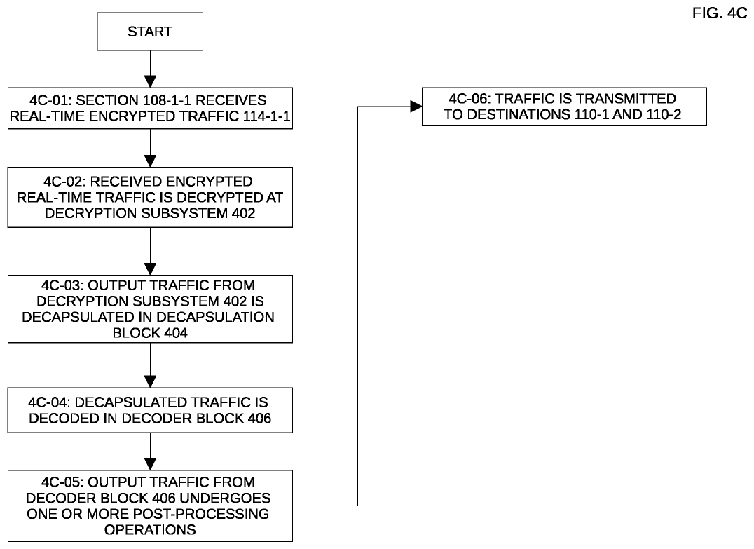

FIG. 4A shows an example section 108-1-1 in a bidirectional node 108-1 to receive encrypted traffic from secure matrix 106. The operation of section 104-1-1 is shown with reference to FIGS. 4A and 4C. In FIG. 4A, in step 4C-01, encrypted traffic 114-1-1 is received in section 108-1-1.

In step 4C-02, the received encrypted traffic 114-1-1 is decrypted at decryption subsystem 402.

Then, in step 4C-03, the decrypted traffic is then decapsulated at decapsulation subsystem 404.

In step 4C-04, some of the decrypted and decapsulated traffic is sent to decoder block 406, where it is decoded and decompressed.

In step 4C-05, the decompressed traffic then undergoes one or more post-processing operations. As explained before, in some embodiments, pre-scaling of video is performed in a bidirectional node within the first set of bidirectional nodes 104-1 to 104-N. As was also explained, this pre-scaling is performed to enable presentation of multiple views in split screens within a single monitor. In some embodiments, the one or more post-processing operations comprise decoding images to, for example, present multiple views in split screens within a single monitor display apparatus.

In other embodiments, the one or more post-processing operations comprise combining multiple video and audio signals from different sources for a user at a destination to view.

In step 4C-06, the post-processed traffic is transmitted to one or more destinations coupled to bidirectional nodes. For example, as shown in FIG. 1A, the post-processed traffic is transmitted to destinations 110-1 and 110-2.

One of skill in the art would appreciate that variations to the above are possible. For example, in some embodiments, some of the decapsulated traffic such as traffic 401-3 exiting decapsulated subsystem 404 then undergoes one or more post-processing operations as described above. Then with reference to the flow shown in FIG. 4C, step 4C-04 are not performed on this traffic.

In yet other embodiments, some of the decapsulated traffic such as traffic 401-1 and 401-2 is directly transmitted to the one or more destinations coupled to the bidirectional node 108-1. Then with reference to the flow shown in FIG. 4C, steps 4C-04 and 4C-05 are not performed on this traffic.

As explained above, the second set of nodes 108-1 to 108-N are bidirectional nodes. Therefore, traffic can be transmitted from the destinations, received at one of the bidirectional nodes, encrypted and transmitted to the secure matrix 106. FIG. 4B shows an example of section 108-1-2 to transmit encrypted real-time media traffic 114-1-2 to the secure matrix 106. In FIG. 4B, traffic 431-1 and 431-2 is received at pre-processing block 443, where it is pre-processed. It is then encrypted at encryption block 441. Encrypted real-time media traffic 114-1-2 is output from encryption block 441 and transmitted to secure matrix 106 via ports 421-1 to 421-L.

In some embodiments, the second set of nodes 108-1 to 108-N receive and transmit encrypted control traffic from and to the container-based subsystem 172 as well. In FIG. 4A, encrypted control traffic 415-1 is received via ports 413-1 to 413-K, where it is decrypted at block 402 and used for further processing as necessary by node 108-1. In FIG. 4B, control traffic is created by node 108-1 and encrypted at block 441 of section 108-1-2. It is then transmitted via ports 423-1 to 423-P as encrypted control traffic 425-1 to secure matrix 106.

The operation of the secure matrix 106 in combination with bidirectional nodes 104-1 to 104-N and bidirectional nodes 108-1 to 108-N is configured and controlled by control plane 170, as will be discussed below. As shown in FIG. 1, control plane 170 comprises administrative authority 178 and container-based subsystem 172.

In some embodiments, container-based subsystem 172 is coupled to bidirectional nodes 104-1 to 104-N, and bidirectional nodes 108-1 to 108-N via secure matrix 106 and control connections 176. In some embodiments, control connections 176 comprises direct connections between container-based subsystem 172 and the bidirectional and bidirectional nodes.

Container-based subsystem 172 configures and controls the bidirectional nodes 104-1 to 104-N, secure matrix 106, and bidirectional nodes 108-1 to 108-N via sending encrypted control messages comprising commands and data. In some embodiments, container-based subsystem 172 sends these encrypted control messages to the bidirectional nodes 104-1 to 104-N and the bidirectional nodes 108-1 to 108-N via control connections 176 and secure matrix 106. As explained above, in some embodiments control connections 176 directly couple container-based subsystem 172 to bidirectional nodes 104-1 to 104-N and bidirectional nodes 108-1 to 108-N. In these embodiments, encrypted control messages are transmitted directly to both sets of bidirectional nodes. The container-based subsystem receives control messages using these same paths.

For example, with reference to FIG. 1A and FIG. 2A the container-based subsystem 172 receives encrypted control traffic from the first set of bidirectional nodes 104-1 to 104-N via one or more control connections 176 and secure matrix 106. As previously explained with reference to FIG. 2A, encrypted control traffic 215-1 is transmitted from bidirectional node 104-1 via one or more control interfaces 213-1 to 213-K. This encrypted control traffic is transmitted via secure matrix 106 and one or more control connections 176 to container-based subsystem 172. The control traffic 215-1 comprises different types of control messages.

In another example, with reference to FIG. 1A and FIG. 2B the container-based subsystem 172 transmits encrypted control traffic to the first set of bidirectional nodes 104-1 to 104-N via one or more control connections 176 and secure matrix 106. As previously explained with reference to FIG. 2B, encrypted control traffic 225-1 is transmitted from container-based subsystem 172. This encrypted control traffic is transmitted via secure matrix 106 and one or more control connections 176 to control interfaces 223-1 to 223-L of section 104-1-2. The control traffic 225-1 comprises different types of control messages.

Similar processes to the above are carried out for the second set of bidirectional nodes 108-1 to 108-N. For example, in node 108-1: With reference to FIG. 1A and FIG. 4A, container-based subsystem 172 transmits encrypted control traffic 415-1 to section 108-1-1 via one or more control connections 176, secure matrix 106 and ports 413-1 to 413-K. With reference to FIG. 1A and FIG. 4B, container-based subsystem 172 receives encrypted control traffic 425-1 from the second set of bidirectional nodes 108-1 to 108-N via control interfaces 423-1 to 423-P, secure matrix 106 and one or more control connections 176 in section 108-1-2.

As explained above, the bidirectional movement of encrypted real-time media traffic between the first set of bidirectional nodes 104-1 to 104-N and the second set of bidirectional nodes 108-1 to 108-N via secure matrix 106 depends on the security levels of the nodes in the first bidirectional set and the second bidirectional set; as well as the security policy. The configuring of secure matrix 106 and directing of the encrypted real-time traffic is performed by container-based subsystem 172 in control plane 170 as follows: A security level, such as a MILS level, is established for each of the first set of bidirectional nodes 104-1 to 104-N and the corresponding coupled source by container-based subsystem 172. For example, the combination of bidirectional node 104-1 and source 102-1 has an associated security level, such as a MILS level. In some embodiments, the MILS level is established during a secure means for registration and discovery of all nodes.

In other embodiments, the MILS level is established as part of a provisioning process, using a separate application for all nodes. A provisioning process is implemented using, for example, a provisioning container or independent server as will be explained below. During a provisioning process, a node's static addresses, such as IP address and multicast addresses for audio and video are set. The provisioning process also places a certificate of authority for the node and cryptographic keys, such as Elliptic-Curve Diffie-Hellman (ECDH) keys. In some embodiments, these certificates of authority comprise private certificates. Then, the MILS level is established for nodes, users, work areas and groups once these steps are complete. This avoids the usage of easily discovered means such as multicast Domain Naming Service (mDNS) or Dynamic Host Configuration Protocol (DHCP). Use of a provisioning container or independent server accomplishes the same as these common protocols without revealing important node information to the network at large.

The container-based subsystem 172 determines which of the bidirectional nodes 108-1 to 108-N and thereby its coupled corresponding destinations, can receive traffic from one of bidirectional nodes 104-1 to 104-N based on the security level of the users at the destinations associated with the bidirectional nodes. Based on this determination, the container-based subsystem determines routes from each of the first set of bidirectional nodes 104-1 to 104-N to the appropriate ones of the second set of bidirectional nodes 108-1 to 108-N via secure matrix 106.

Users are listed in the system by MILS level. When a user logs in at one or more of the destinations 110-1 to 110-N, the user's MILS level and other job-related information such as job function identification (ID) number are retrieved. Then, the bidirectional node that is associated with and coupled to the one or more destinations receives the entered security level and other job-related information, and assigns this security level to the one or more destinations. In some embodiments, a security level is assigned to the seat. For example, referring to FIG. 1A, if a user logs in at destinations 110-1 and 110-2, which are connected to associated bidirectional node 108-1, then the seat 154 comprising bidirectional node 108-1 and destinations 110-1 and 110-2 are assigned with a security level. The entered security level and job-related information is transmitted to, for example, the container-based subsystem 172 in control plane 170 from the associated bidirectional node 108-1.

Then, the administrator uses administrative devices 178 to check:
the security level of the first set of bidirectional nodes 104-1 to 104-N, and
the security level of the second set of bidirectional nodes 108-1 to 108-N,
to see where there are matches in accordance with a security policy.

Different security policies are possible. In some embodiments, users can see information at either their security level or lower. So, for example, a user with a Top Secret security level is able to see information which is at a Top Secret level or at a lower level, such as Secret, Unclassified and Classified. So, for example, if the user is at seat 154 and has Top Secret security level, the user will only be able to receive and transmit real-time media traffic to a bidirectional node in the first set of bidirectional nodes which is either at Top Secret security level or lower.

In other embodiments, users can only see information at their security level. For example, a user with a Top Secret security level can only see information at a Top Secret level. So, for example, if the user is at seat 154 and has Top Secret security level, the user will only be able to receive and transmit real-time media traffic to a bidirectional node in the first set of bidirectional nodes which is also at Top Secret security level.

If the user is replaced by another user with a different security level, the matching process is repeated, taking into account the changed security level.

In some embodiments, the matching is based on other factors. In some embodiments, the user's job function or job title is taken into account as well. For example, a user is matched with a source and its corresponding bidirectional node, even though the security levels are compatible, as the source is considered to not be relevant to the user.

Once the matching is completed, then an administrator using administrative devices 178 assigns sources to a GUI such as a touch panel associated with the one or more destinations or a seat such as seat 154 of FIG. 1A. This enables the user to transmit traffic to or receive traffic from the sources. Administrative devices 178 will be explained further below.

For example, as explained previously, the user at seat 154 has two destinations 110-1 and 110-2. These are, for example, two monitors. A set of four (4) senders are configured by the administrative authority 178 for the user. The touch panel associated with seat 154 gives the user a choice among the four (4) sources. For example, if one of the four senders is source 102-1, then the user can transmit traffic such as USB traffic to source 102-1, or receive traffic from source 102-1. Source 102-1 is coupled to bidirectional node 104-1. Then, the secure matrix 106 will connect bidirectional node 104-1 to bidirectional node 108-1.

With reference to FIG. 3, once the container-based subsystem 172 has received the user selections and has determined which routes need to be set up between the endpoints 301 and 305, the container-based subsystem 172 performs scheduling which comprises configuring the leaf switches 302 and 303; and spine switch 304 to meet these needs while ensuring balancing of the traffic loads at these uplink ports of the switches and the continued maintenance of the non-blocking nature of the Ethernet network fabric.

The container-based subsystem 172 is described in more detail below: In some embodiments, each of the control functions implemented within container-based subsystem 172 are broken down into Docker containers, such as containers 174-1 to 174-M of FIG. 1. These containers comprise, for example:
At least one of the previously described SDN container to manage network uplink connections between switches in the secure matrix and provide switching for connecting nodes;
At least one database container to manage the inventory of the bidirectional nodes and the signal types being managed such as audio, video and USB for example. Signals types could be numerous depending on the need for other types of data such as serial data as an example;
At least one switch container to enable switching of real-time traffic from source to destination;
At least one topology container to enable identification of all objects and to manage the audio, video and USB flows;
At least one control system containers to enable configuration of the system;
At least one Lightweight Directory Access Protocol (LDAP) or Active Directory Authentication container to manage tokens such as OAuth2 tokens or JavaScript Object Notation (JSON) Web Tokens (JWT);
At least one logging and audit container to manage all system logging and auditing;
At least one third party API container to manage non-secure access; and
At least one provisioning container or independent provisioning server that
   sets all node addresses with static addresses,
   assigns certificates of authority which, as explained previously, comprise private certificates in some embodiments, and
   assign cryptographic keys such as ECDH keys, to all systems.
      The list above is not exhaustive by any means. For example, as explained previously, one or more containers are in used in some embodiments to implement a recorder subsystem such as recorder subsystem 212.

As previously explained, the SDN container performs the task of connecting nodes from one switch to another as well as management of the uplink ports. Further details are provided below. The SDN container connects sets of bidirectional nodes to each other and manages uplink ports between switches. As explained before, the SDN container is aware of all nodes and all switches that the nodes are connected to.

The SDN container works in concert with the secure matrix 106 via control connections 176. This SDN service has awareness of the connection matrix and is aware of connections that are in place and connections are being requested. In this way, the SDN service performs scheduling of the various flows, taking into account the capacity of the secure matrix and the need to balance flows and ensure that uplink and downlink ports are not overwhelmed. The SDN container communicates to other container-based containers in an encrypted manner as with other physical nodes.

In some embodiments, the security policy is implemented using the OAuth 2.0 protocol. Then, the MILS Server issues access tokens to a bidirectional node from either the first or the second set of bidirectional nodes based on the security level of the bidirectional node and the security levels of either the first or the second sets of bidirectional nodes; and the security policy. The process of matching in accordance with security policy has been explained above. For example, in the case of the user occupying seat 154 in FIG. 1A, where there is a match in accordance with the security policy, the MILS Server issues an access token for bidirectional node 108-1 to access the bidirectional nodes in first set 104-1 to 104-N. This access token is provided to the SDN container, so that the SDN container is able to make the appropriate connections via the secure matrix 106.

Containers use cryptographic modules such as FIPS cryptographic modules to encrypt traffic, and are mutually authenticated and architected in accordance with known confidentiality and security standards and specifications. In this manner, the containers are secured entities as are all the connected nodes, so that any connection of container to container, or container to node, requires a secure path using sufficiently strong encryption such as FIPS encryption.

Using a container-based subsystem for control and configuration provides the following advantages over prior art monolithic controllers. The main advantage is how the container-based Docker containers are placed. In monolithic architectures, the software and hardware have to be together and are often place on premises with a main and redundant controller scheme. With the container-based Docker containers, these containers can be on premises or in the cloud. The container-based containers can also be redundant and scalable and can grow over time on various hardware on servers or virtual servers.

In some embodiments, the container-based subsystem is implemented using a cloud-based implementation. In some embodiments, the container-based subsystem is implemented using on-premises hardware. In other embodiments, the container-based subsystem is implemented using off-premises hardware.

Referring to FIG. 1A, the administrative devices 178 comprises one or more devices. Then, an administrator interacts with administrative devices 178 to select the bidirectional nodes which are applicable to a particular user, and for which they are authorized to access based on their MILS level. In this manner, the audio, video and USB can be selected and connected to suit the workflow of a particular user, and ensure that users only receive traffic which they are authorized to receive, or that users only connect to traffic destinations which they are authorized to connect to. The administrative devices 178 are coupled to container-based subsystem 172. In some embodiments, this occurs via secure matrix 106. Requests and data are sent to container-based system 172 via, for example, a GUI available to administrative devices 178. These requests are encrypted at administrative devices 178 before being sent to secure matrix 106. The sent requests are checked by the container-based subsystem 172 to ensure security level matching as described above, before denying or honoring the requests to connect the bidirectional nodes in one set to bidirectional nodes in the other set. Most all functions that require user intervention for user requests are done with these administrative devices 178.

In some embodiments, all of the bidirectional nodes 104-1 to 104-N and 108-1 to 108-N operate in a mode which is compatible with a governmental or military encryption standard, such as the US National Institute of Standards and Technology (NIST) FIPS. This comprises ascertaining that the node is clear for communications using a certified FIPS Cryptographic Module Validation (CMVP) module. In some embodiments, all of the devices utilizing the FIPS module must complete a self-test to insure it is running in a valid FIPS mode before it is allowed to communicate with other devices.

Once running in FIPS mode, the node connects with the provisioning container in container-based subsystem 172 to establish the audio, video and USB capabilities of the node. In some embodiments, the registration includes storing information that a particular node is a bidirectional node and that it has video, audio and USB ports that it can be assigned to connect with.

The node is then assigned an address and domain in which it will operate under, as well as all requisite multicast or unicast address assignments for audio, video or USB.

In some embodiments, all nodes and containers within the container-based subsystem 172 communicate only using FIPS encrypted traffic. In these embodiments, each node and container protects its private key and root certificates by storing this information in objects such as Trusted Protection Module (TPM) platforms and Hardware Security Module (HSM) platforms. In this manner, sensitive private keys are protected to insure secure communications with approved FIPS encryption methodologies. In some embodiments, these private keys are user assigned. Then, the vendor does not issue these keys. Instead, the vendor provides the provisioning method to place the private keys and Certificate of Authority in the TPM.

In some embodiments, data plane 140 does not connect to other networks directly as the large payloads may disrupt these other networks.

In other embodiments, data plane 140 is connected to other networks which are capable of receiving these large payloads. In some of these embodiments, the transcoder node 210 of FIG. 2 performs transcoding from mezzanine to motion-based codecs and vice versa to accommodate the needs of the other networks as necessary.

Using secured IP transport with encryption allows for the first set of bidirectional nodes 104-1 to 104-N and the second set of bidirectional nodes 108-1 to 108-N to connect within a sensitive facility such as a Sensitive Compartmented Information Facility (SCIF), Situation Room, Video Teleconference Centers and other secured operational areas. In some embodiments, SCIFs are secured rooms, for example, in the case of the private sector. When there is a need to distribute some audio, video and USB to secure areas outside the SCIF, as explained above transcoder node 210 in FIG. 2A performs transcoding as necessary. This transcoded version facilitates the use of a “virtual SCIF” where parts of the main SCIF are shared with secured entities outside the main SCIF environment.

In some embodiments, each seat in a SCIF is assigned a different security level for every session, as different users with different security levels enter and leave the SCIF between sessions. Then the matching process described above is performed for each session.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

1. A system for delivering real-time media traffic, comprising:
a secure matrix communicatively coupled to a first set of bidirectional nodes, a second set of bidirectional nodes, and a control plane, wherein
the first set of bidirectional nodes comprises a first bidirectional node communicatively coupled to a source,
the first bidirectional node and the source having a first security level,
the second set of bidirectional nodes comprises a second bidirectional node communicatively coupled to one or more destinations,
the second bidirectional node and the one or more destinations having a second security level,
the real-time traffic comprises a first real-time media traffic received by the first bidirectional node from the source,
the first bidirectional node transmits a first encrypted real-time traffic to the secure matrix, further wherein
the first encrypted real-time media traffic is based on the received first real-time media traffic, and
the control plane, using flow-based programming, configures the secure matrix to direct the first encrypted real-time traffic to the second bidirectional node, further wherein
the directing is based on the first security level, the second security level, and a security policy,
the second bidirectional node transmits a first decrypted real-time media traffic to the one or more destinations, and
the first decrypted real-time media traffic is based on the first encrypted real-time media traffic.

2. The system of claim 1, wherein the directing occurs when the second security level is either the same as or higher than the first security level.

3. The system of claim 1, wherein the control plane is container-based.

4. The system of claim 1, wherein the first real-time media traffic comprises at least one of audio, video and Universal Serial Bus (USB) traffic.

5. The system of claim 1, wherein the first real-time media traffic is encrypted at the first set of bidirectional nodes in accordance with a governmental or military standard.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. The system of claim 1, wherein
a user is associated with the one or more destinations, further wherein
a user security level is associated with the user; and
the control plane comprises one or more administrative devices to enable an administrator to select the second bidirectional node, further wherein
the selecting is based on the second security level and the associated user security level.

25. The system of claim 1, wherein the secure matrix is communicatively coupled to the control plane via one or more control connections.

26. The system of claim 3, wherein
the control plane comprises a container; and
the container stores a private key in an object.

27. The system of claim 1, wherein
the control plane is coupled to the first and the second set of bidirectional nodes via one or more control connections;
a first one or more encrypted control messages are transmitted by the control plane to the first and the second set of bidirectional nodes; and
a second one or more encrypted control messages are transmitted by either the first set or the second set of bidirectional nodes to the control plane.

28. The system of claim 26, wherein the object is either a Trusted Protection Module platform or a Hardware Security Module platform.

29. A method for delivery of real-time media traffic, comprising:
receiving, at a first bidirectional node, a first real-time media traffic from a source,
the first bidirectional node and the first source having a first security level;
transmitting, from the first bidirectional node, a first encrypted real-time traffic based on the received first real-time media traffic; and
configuring, using flow-based programming, a secure matrix to direct the first encrypted real-time traffic to a second bidirectional node, wherein
the second bidirectional node and one or more destinations have a second security level, and
the directing is based on the first security level, the second security level and a security policy.

30. The method of claim 29, wherein the second security level is either the same as or higher than the first security level.

31. The method of claim 29, wherein the control plane is container-based.

32. The method of claim 29, wherein the first real-time media traffic comprises at least one of audio, video and Universal Serial Bus (USB) traffic.

33. The method of claim 29, wherein the first real-time media traffic is encrypted at the first set of bidirectional nodes in accordance with a governmental or military standard.

34. The method of claim 29, wherein
a user is associated with the one or more destinations, and
a user security level is associated with the user; and
the method further comprises
enabling an administrator to perform selecting of the second bidirectional node, wherein the selecting is based on the second security level and the associated user security level.

35. A method for delivery of real-time media traffic, comprising:
providing a secure matrix communicatively coupled to a first and a second set of bidirectional nodes,
the first set of bidirectional nodes comprising a first bidirectional node,
the first bidirectional node communicatively coupled to a first source,
the first bidirectional node receiving a first real-time media traffic from the first source and transmitting a first encrypted real-time traffic to the secure matrix,
the first encrypted real-time traffic based on the received first real-time media traffic, and
the first bidirectional node and the first source having a first security level; and
providing a control plane communicatively coupled to the secure matrix, wherein the control plane configures, using flow-based programming, the secure matrix to direct the first encrypted real-time traffic to the second set of bidirectional nodes, further wherein
the second set of bidirectional nodes comprises a second bidirectional node,
the second bidirectional node is communicatively coupled to the one or more destinations,
the second bidirectional node and the one or more destinations having a second security level, and
the first encrypted real-time traffic is directed to the second bidirectional node based on the first security level, the second security level and a security policy.

36. The method of claim 35, wherein
the control plane comprises a container; and
the method comprises storing, by the container, a private key in an object.

37. The method of claim 36 wherein the object is either a Trusted Protection Module platform or a Hardware Security Module platform.

38. The method of claim 35, further wherein
the control plane transmits a first one or more encrypted control messages to the first set and the second set of bidirectional nodes; and
the control plane receives a second one or more encrypted control messages from either the first set or the second set of bidirectional nodes.
